(19) United States
(12) Patent Application Publication
(10) Pub. No.: US 2025/0298473 A1
(43) Pub. Date: Sep. 25, 2025

(54) INPUT DEVICE

(71) Applicant: EMRight Technology Co., Ltd., Hsinchu County (TW)

(72) Inventors: Tsung-Tse Hung, Hsinchu County (TW); Hung-I Wang, Hsinchu County (TW); Lin-Ying Lee, Hsinchu County (TW); Chun Hao Chen, Hsinchu County (TW); Chiu-Feng Huang, Hsinchu County (TW)

(73) Assignee: EMRight Technology Co., Ltd., Hsinchu County (TW)

(21) Appl. No.: 19/083,394

(22) Filed: Mar. 18, 2025

(30) Foreign Application Priority Data
Mar. 25, 2024 (TW) 113111093

(51) Int. Cl. G06F 3/038; G06F 3/0354

(52) U.S. Cl. CPC G06F 3/0383; G06F 3/03543; G06F 3/03545

(57) ABSTRACT

An input device includes an encoding plate, a connecting mechanism, a resonance circuit, and M−1 first capacitors. The encoding plate has N fields, each field has M partitions, and there is an electrode on at least one of the partitions of each of the fields. In each field, the electrodes on the corresponding partitions are electrically coupled to each of multiple contacts, wherein the contacts include a first contact and M−1 second contacts. The connecting mechanism is configured to determine whether to connect at least one of the first contact and the second contacts. The resonance circuit is electrically coupled to the first contact and configured to provide an encoded signal with an encoded frequency. The M−1 first capacitors are electrically coupled between the second contacts and the resonance circuit respectively.

### CROSS-REFERENCE TO RELATED APPLICATION

This application claims the priority benefit of Taiwan application serial no. 113111093, filed on Mar. 25, 2024. The entirety of the above-mentioned patent application is hereby incorporated by reference herein and made a part of this specification.

### BACKGROUND OF THE INVENTION

### Field of the Invention

The invention relates to an input device, and more particularly to an input device capable of improving the accuracy of a received input signal.

### Description of Related Art

Conventional mice and scroll wheels, optical or mechanical encoders, may quickly determine the scrolling direction of the scroll wheel by using a plurality of switches with delayed switching, in conjunction with logic circuits or processors. However, it is extremely difficult to interpret optical or mechanical encoder signals by using the scroll wheel on an Electro-Magnetic Resonance (EMR) pen or mouse. Usually, EMR pens transmit information between the sensor plate and the EMR pen or mouse through resonance. Since the report rate of EMR is usually between 100 to 1000, at such speeds, the wheel, optical or mechanical encoder that needs to distinguish the original technique is very likely to fail to distinguish.

### SUMMARY OF THE INVENTION

The invention provides an input device that may improve the accuracy of the received input signal.

An input device of the invention includes an encoding plate, a connecting mechanism, a resonance circuit, and M−1 first capacitors. The encoding plate has N fields, each of the fields has M partitions, and there is an electrode on at least one of the partitions of each of the fields. In the fields, the electrodes on the corresponding partitions are electrically coupled to each of a plurality of contacts, wherein the contacts include a first contact and M−1 second contacts, wherein N=2^{M-1}, and M is an integer greater than 1. The connecting mechanism is configured to determine whether to connect at least one of the first contact and the second contacts. The resonance circuit is electrically coupled to the first contact and configured to provide an encoded signal with an encoding frequency. The M−1 first capacitors are electrically coupled between the second contacts and the resonance circuit respectively.

Based on the above, the input device of the invention electrically couples the resonance circuit to one or a plurality of first capacitors via a connecting mechanism, and adjusts the encoding frequency of the generated encoded signal according to the capacitance values of the one or plurality of first capacitors electrically coupled. The input device of the invention obtains the input command performed by the user by identifying the encoding frequency of the encoded signal, thereby reducing the occurrence of input signal reception failure caused by insufficient signal recognition.

### BRIEF DESCRIPTION OF THE DRAWINGS

FIG. 1 shows a schematic diagram of an input device of an embodiment of the invention.

FIG. 2A and FIG. 2B are schematic diagrams respectively showing implementations of an encoding plate and a connecting structure in an input device of an embodiment of the invention.

FIG. 3A and FIG. 3B are schematic diagrams respectively showing implementations of an encoding plate and a connecting structure in an input device of an embodiment of the invention.

FIG. 4A and FIG. 4B are schematic diagrams showing the layered architecture of an encoding plate in an input device of an embodiment of the invention.

FIG. 5 is a schematic diagram showing an implementation of a resonance circuit of an input device of an embodiment of the invention.

### DESCRIPTION OF THE EMBODIMENTS

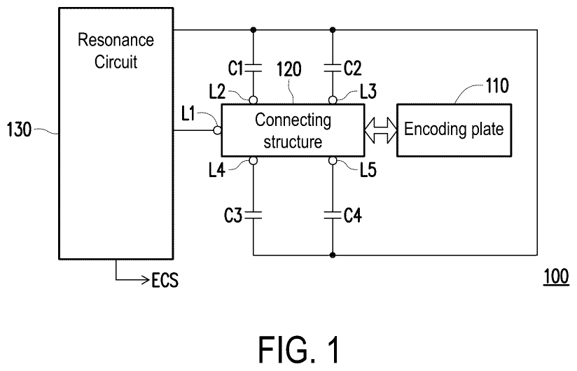

Please refer to FIG. 1. FIG. 1 shows a schematic diagram of an input device of an embodiment of the invention. An input device 100 includes an encoding plate 110, a connecting structure 120, a resonance circuit 130, and a plurality of capacitors C1 to C4. The encoding plate 110 and the connecting structure 120 are electrically coupled to each other. The connecting structure 120 is electrically coupled to a plurality of contacts L1 to L5, wherein in combination with the encoding plate 110, the connecting structure 120 may connect the contact L1 with at least one of the contacts L2 to L5, or the connecting structure 120 may also not connect the contact L1 with any of the contacts L2 to L5.

The resonance circuit 130 is electrically coupled to the contact L1 and electrically coupled to the connecting structure 120 through the contact L1. The capacitors C1 to C4 are electrically coupled to the contacts L2 to L5, respectively. When each of the contacts L2 to L5 is electrically coupled to the contact L1, the corresponding capacitors C1 to C4 can be connected in parallel with the resonance circuit 130. The resonance circuit 130 may include a built-in capacitor. The built-in capacitor in the resonance circuit 130 can be connected in parallel with one or a plurality of the capacitors C1 to C4, or be disconnected from any of the capacitors C1 to C4, according to the connection relationship between the contact L1 and the contacts L2 to L5. The resonance circuit 130 is configured to generate an encoded signal ECS. The encoded signal ECS has an encoding frequency, and the encoding frequency may be adjusted according to the equivalent capacitance value formed by the built-in capacitor and the capacitors C1 to C4. In the present embodiment, when the built-in capacitor is not connected to any of the capacitors C1 to C4, the encoded signal ECS may have the highest encoding frequency. When the built-in capacitor is connected in parallel with all the capacitors C1 to C4, the encoded signal ECS may have the lowest encoding frequency.

In the present embodiment, the capacitance values of C1 to C4 may all be unequal. In an embodiment of the invention, the capacitance values of C1 to C4 can form a geometric progression in sequence, and the capacitance value ratio of the capacitors C1 to C4 may be, for example, 1:2:4:8.

In the present embodiment, when the input device 100 is, for example, a mouse (or an Electro-Magnetic Resonance (EMR) pen), the connecting structure 120 can be correspondingly configured on the scroll wheel of the mouse. When the user rotates the scroll wheel, the connecting structure 120 can correspondingly move or rotated, thereby changing the connection relationship between the contact L1 and the contacts L2 to L5. Correspondingly, the encoding frequency of the encoded signal ECS generated by the resonance circuit 130 can be modulated in response to the rotation of the scroll wheel. Accordingly, the input device 100 can detect changes in the encoding frequency of the encoded signal ECS to determine the input command transmitted by the user.

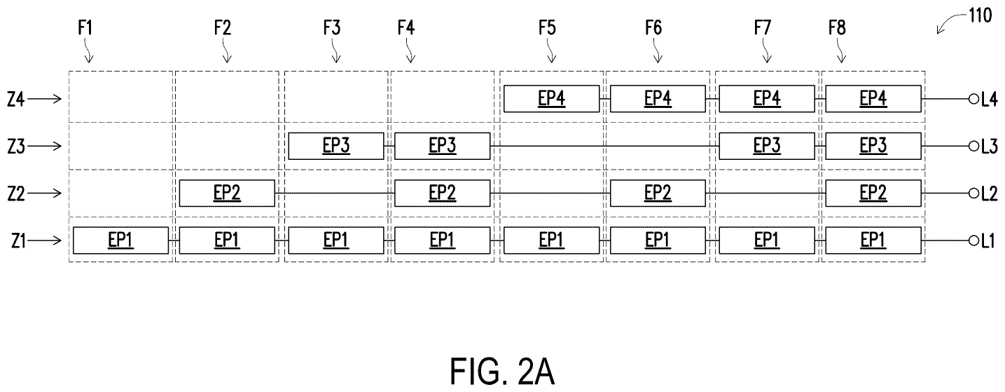

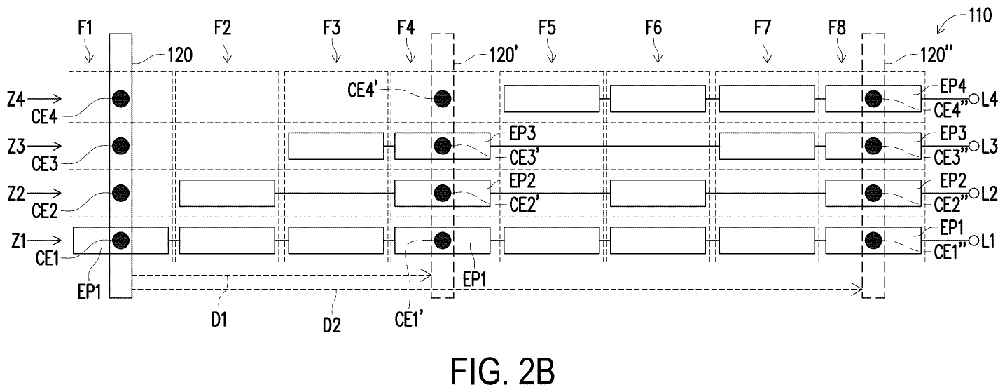

For implementation details of the encoding plate 110 and the connecting structure 120, reference can be made to FIG. 2A and FIG. 2B. FIG. 2A and FIG. 2B respectively illustrate schematic diagrams of the implementation of the encoding plate and the connecting structure in the input device of the embodiments of the present invention. In FIG. 2A, the encoding plate 110 may have a plurality of fields F1 to F8, and each field F1 to F8 includes a plurality of partitions Z1 to Z4. Wherein, the number N of the fields F1 to F8 is equal to 2 raised to the power of (M minus 1), where M represents the number of partitions, and M is an integer greater than 1. In each partitions Z1 to Z4 of the fields F1 to F8, any of electrodes EP1 to EP4 may be set or not set.

In addition, on the encoding plate 110, all electrodes in the same partitions Z1 to Z4 corresponding to different fields F1 to F8 are electrically connected to each other and electrically coupled to the contacts L1 to L4, respectively. In detail, the electrode EP1 in partition Z1 of fields F1 to F8 can be commonly connected to the contact L1 via a wire; the electrode EP2 in partition Z2 of fields F1 to F8 can be commonly connected to the contact L2 via a wire; the electrode EP3 in partition Z3 of fields F1 to F8 can be commonly connected to the contact L3 via a wire; and the electrode EP4 in partition Z4 of fields F1 to F8 can be commonly connected to the contact LA via a wire.

In addition, in the present embodiment, the electrode EP1 is disposed in partition Z1 of all fields F1 to F8. In partition Z2 of fields F1 to F8, only half of them are provided with the electrode EP2. In partition Z3 of fields F1 to F8, only half of them are provided with the electrode EP3. In partition Z4 of fields F1 to F8, similarly, only half of them are provided with electrode EP4. From the perspective of encoding, if each of the fields F1 to F8 has an electrode disposed in each of the partitions Z2 to Z4, a binary value of 1 may be represented, and if each of the fields F1 to F8 has no electrode disposed in each of the partitions Z2 to Z4, a binary value of 0 may be represented. In the present embodiment, the field F1 may correspond to a digital value of 0 (binary 000); the field F2 may correspond to a digital value of 1 (binary 001); . . . ; the field F8 may correspond to a digital value of 7 (binary 111).

It is worth mention that, in the physical arrangement of the encoding plate 110, the fields F1 to F8 do not need to be arranged in order according to their corresponding numeric values but can be set in any arbitrary sequence. Furthermore, the number of fields and partitions is not limited to the illustration in FIG. 2A, and the number of partitions can be any integer greater than 1, while the number of fields can be 2^{M-1}.

In FIG. 2B, the connecting mechanism 120 is movably arranged on the encoding plate 110. Corresponding to the positions of the plurality of partitions Z1 to Z4 on the encoding plate 110, the main body of the connecting mechanism 120 is a conductive structure and may have a plurality of contacts CE1 to CE4. In particular, the contacts CE1 to CE4 are used to electrically couple to the electrodes on the plurality of partitions Z1 to Z4 of the corresponding fields F1 to F4 at the location of the connecting mechanism 120.

For example, when the connecting mechanism 120 is positioned above the field F1, the contact CE1 on the connecting mechanism 120 can be electrically coupled to the electrode EP1 in the partition Z1, and further electrically coupled to the contact L1, while contacts CE2 to CE4 are left unconnected). And since no electrodes are set in the partitions Z2 to Z4 of field F1, the connecting mechanism 120 is not electrically coupled to the contacts L2 to L4. At this time, the contact L1 is not electrically coupled to the contacts L2 to L4. When the connecting mechanism 120 moves by a displacement D1 according to the user's input command, the connecting mechanism 120′ is then located above the field F4. At this position, the contacts CE1′, CE2′, and CE3′ of the connecting mechanism 120′ are electrically coupled to the electrodes EP1 to EP3 on the partitions Z1 to Z3 in the field F4 respectively while contact CE4′ remains unconnected. Therefore, the contacts L1, L2, and L3 can be electrically coupled together through the connecting mechanism 120′. In addition, when the connecting mechanism 120 moves by a displacement D2 in response to the input command of the user, the connecting mechanism 120″ is then positioned above the field F8. At this position, the contacts CE1″, CE2″, CE3″, and CE4″ of the connecting mechanism 120″ are electrically coupled to the electrodes EP1 to EP4 in the partitions Z1 to Z4 of field F8, respectively. Therefore, the contacts L1, L2, L3, and L4 can be electrically coupled together through the connecting mechanism 120″.

In the present embodiment, the contact L1 serves as a first contact, while the contacts L2 to L4 function as a plurality of second contacts. In particular, the first contact (the contact L1) is electrically coupled to a plurality of electrodes EP1 on the partition Z1 (the first partition), and the second contact (the contact L2 as an example) can be electrically coupled to each electrode EP2 on the second partition (the partition Z2) which is non-first partition. Taking the connecting mechanism 120′ as an example, in addition to being connected to the contact L1 (the first contact) through the contact CE1′, the connecting mechanism 120′ also connects to the contacts L2, L3, L4 which correspond to partitions electrodes EP2, EP3, EP4 through the contacts CE2′, CE3′, and CE4′, respectively. As a result, the contact L1 is electrically coupled to the selected contacts L2, L3, L4.

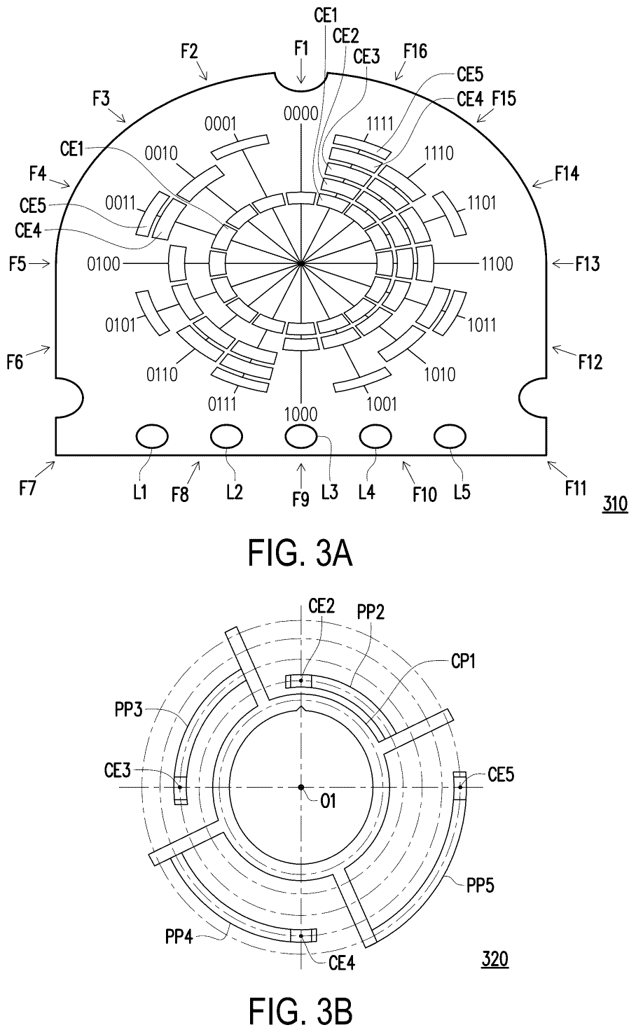

Please refer to FIG. 3A to FIG. 3B below. FIG. 3A and FIG. 3B are schematic diagrams respectively showing implementations of an encoding plate and a connecting structure in an input device of an embodiment of the invention. In FIG. 3A, the encoding plate 310 has a plurality of fields F1 to F16, arranged around a central portion. Each of the fields F1 to F16 has five partitions, and the plurality of partitions of the fields F1 to F16 can be arranged in a plurality of concentric circles surrounding the central area. Furthermore, the plurality of partitions of each fields F1 to F16 radiate outward from the center. Taking the field F16 as an example, the first partition is used to dispose the electrode CE1; the second partition is used to dispose the electrode CE2; the third partition is used to dispose the electrode CE3; the fourth partition is used to dispose the electrode CE4; and the fifth partition is used to dispose the electrode CE5. Taking the field F4 as an example, the first partition is used to dispose the electrode CE1; the second and third partitions have no electrodes; the fourth partition is used to dispose the electrode CE4; and the fifth partition is used to dispose the electrode CE5.

In the encoding plate 310, the electrode CE1 in the first partition can be electrically coupled to the contact L1 via a wire (not shown); the electrode CE2 in the second partition can be electrically coupled to the contact L2 via a wire (not shown); the electrode CE3 in the third partition can be electrically coupled to the contact L3 via a wire (not shown); the electrode CE4 in the fourth partition can be electrically coupled to the contact L4 via a wire (not shown); and the electrode CE5 in the fifth partition can be electrically coupled to the contact L5 via a wire (not shown).

In the present embodiment, based on the configuration states of the electrodes CE2 to CE5 in the second to fifth partitions of each fields F1 to F16, the fields F1 to F16 correspond to digital values 0 (binary 0000) to 15 (binary 1111) respectively.

In FIG. 3B, the connecting structure 320 may be a ring-shaped structure corresponding to the encoding plate 310. The connecting structure 320 has a circular central portion CP1, wherein the central portion CP1 may correspond to the position of the first partition in the encoding plate 310. The central portion CP1 may have a plurality of contacts to be electrically coupled to the plurality of electrodes EP1 in the first partition of the encoding plate 310. The connecting structure 320 may further include a plurality of arc-shaped extending portions PP2 to PP5. The extending portions PP2 to PP5 respectively have a plurality of contacts CE2 to CE5 thereon. The contacts CE2 to CE5 correspond to the second to fifth partitions of different fields on the encoding plates 310, and are used to electrically couple to the electrodes in the second to fifth partitions. Furthermore, the central portion CP1 and the extending portions PP2 to PP5 in the present embodiment may all be conductive structures.

It is worth mentioning that the connecting structure 320 can rotate based on the center point O1. The fields F1 to F16 respectively corresponding to the contacts CE2 to CE5 are adjusted accordingly. The connecting structure 320 may be linked to the scroll wheel mechanism on the mouse or the EMR pen and used to receive the input command from the user.

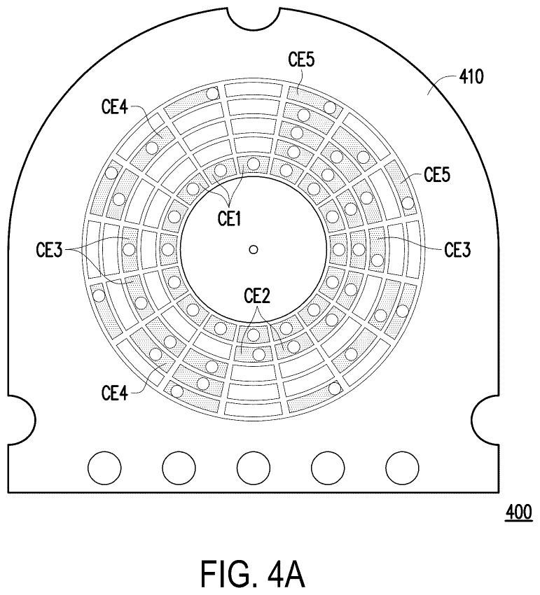

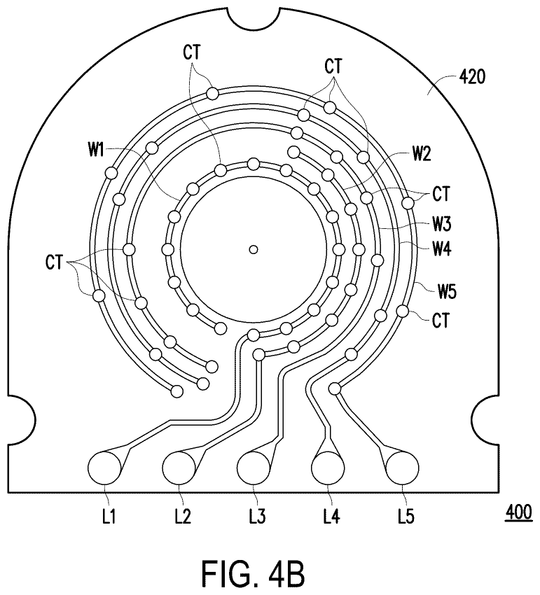

Please refer to FIG. 4A and FIG. 4B below. FIG. 4A and FIG. 4B are schematic diagrams showing a layered architecture of an encoding plate in an input device of an embodiment of the invention. In FIG. 4A, an architecture 410 is a schematic diagram of a first-layer structure of the encoding plate 400. A plurality of electrodes CE1 to CE5 are disposed on the architecture 410, wherein the electrode CE1 is positioned in the innermost ring of the architecture 410 to form a circular ring. The electrodes CE2 to CE5 are respectively arranged on a plurality of concentric rings surrounding the circular ring. In FIG. 4A, the arrangement details of the electrodes CE1 to CE5 are similar to those in FIG. 3, and are not described in detail herein.

In FIG. 4B, an architecture 420 is a schematic diagram of a second-layer structure of the encoding plate 400. The architectures 410 and 420 are disposed to overlap each other. The architecture 420 includes a plurality of wires W1 to W5 therein, and each of the wires W1 to W5 has a plurality of contacts CT thereon. The wires W1 to W5 are electrically coupled to the contacts L1 to L5, respectively. Furthermore, the wire W1 is electrically coupled to the electrode CE1 in the architecture 410 through a contact; the wire W2 is electrically coupled to the electrode CE2 in the architecture 410 through a contact; the wire W3 is electrically coupled to the electrode CE3 in the architecture 410 through a contact; the wire W4 is electrically coupled to the electrode CE4 in the architecture 410 through a contact; and the wire W5 is electrically coupled to the electrode CE5 in the architecture 410 through a contact.

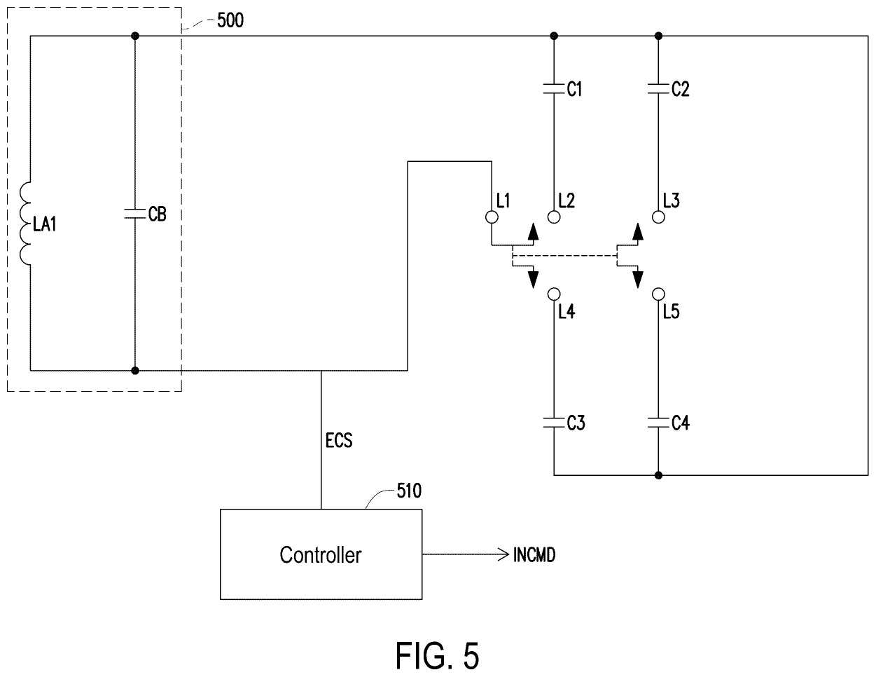

Please refer to FIG. 5 below. FIG. 5 is a schematic diagram showing an implementation of a resonance circuit of an input device of an embodiment of the invention. The resonance circuit 500 is electrically coupled to the controller 510 and the contact L1. The resonance circuit 500 can also be electrically coupled to at least one of the contacts L2 to L4 through the contact L1. By electrically coupling between the contact L1 and the contacts L2 to L4, at least one of the capacitors C1 to C4 and the resonance circuit 500 may be electrically coupled to each other.

In the present embodiment, the resonance circuit 500 includes a capacitor CB and an inductor LA1. The capacitor CB and the inductor LA1 are coupled in parallel. The inductor LA1 may be configured to sense an electromagnetic wave signal provided externally, and the resonance circuit 500 can generate an encoded signal ECS based on the electromagnetic wave signal. In particular, the encoded signal ECS has an encoding frequency, and the magnitude of the encoding frequency is associated with the equivalent capacitance value of the resonance circuit 500. In the present embodiment, the equivalent capacitance value on the resonance circuit 500 may be changed by electrically coupling the contact L1 and at least one of the contacts L2 to L4 to each other, or not connecting the contact L1 and the contacts L2 to L4. The connection relationship between the contact L1 and the contacts L2 to L4 can be adjusted through the connecting mechanism, in conjunction with the encoding plate, by performing rotational or translational movements. The interaction between the connecting mechanism and the encoding plate has been described in detail in the previous embodiments and will not be redundantly explained here.

In the present embodiment, the capacitance values of capacitors C1 to C4 are 1 pf (picofarad), 2 pf, 4 pf, and 8 pf as an example. The connection relationship between the contact L1 and the contacts L2 to L4, as well as the corresponding equivalent capacitance accumulated through parallel coupling of C1 to C4, can be shown in the following table:

| | 0000 | 0001 | 0010 | 0011 | 0100 | 0101 | 0110 | 0111 | 1000 | 1001 | 1010 | 1011 | 1100 | 1101 | 1110 | 1111 |
|---|---|---|---|---|---|---|---|---|---|---|---|---|---|---|---|---|
| L2(1 pf) | | 1 pf | | 1 pf | | 1 pf | | 1 pf | | 1 pf | | 1 pf | | 1 pf | | 1 pf |
| L3(2 pf) | | | 2 pf | 2 pf | | | 2 pf | 2 pf | | | 2 pf | 2 pf | | | 2 pf | 2 pf |
| L4(4 pf) | | | | | 4 pf | 4 pf | 4 pf | 4 pf | | | | | 4 pf | 4 pf | 4 pf | 4 pf |
| L5(8 pf) | | | | | | | | | 8 pf | 8 pf | 8 pf | 8 pf | 8 pf | 8 pf | 8 pf | 8 pf |
| * | 0 pf | 1 pf | 2 pf | 3 pf | 4 pf | 5 pf | 6 pf | 7 pf | 8 pf | 9 pf | 10 pf | 11 pf | 12 pf | 13 pf | 14 pf | 15 pf |

* after parallel accumulation

In particular, the equivalent capacitance provided by the capacitors C1 to C4 via parallel accumulation can further be connected in parallel with the capacitor CB, thereby adjusting the encoding frequency of the encoded signal ECS.

Moreover, the controller 510 is used to receive the encoded signal ECS, and obtain the input command INCMD of the user by detecting the encoding frequency of the encoded signal ECS. In particular, the controller 510 may include a frequency detection circuit, wherein the frequency detection circuit can be implemented by using a frequency detection circuit well known to those skilled in the art without any particular limitation.

In the present embodiment, when the scroll wheel drives the connecting mechanism to roll in the first direction, the input device can sequentially provide incrementing digital values from 0000->0001->0010->0011-> . . . >1110->1111, corresponding to an equivalent capacitance 1 pf->2 pf->3 pf->4 pf-> . . . >14 pf->15 pf to the resonance circuit 500. The resonance circuit 500 can correspondingly cause the encoding frequency of the encoded signal ECS to sequentially decrease from high to low. Of course, the input device can also sequentially provide decreasing digital values from 1111->1110->1101->1100-> . . . >0001->0000, and corresponding to an equivalent capacitance of 15 pf->14 pf->13 pf->12 pf-> . . . >2 pf->1 pf to the resonance circuit 500. The resonance circuit 500 can correspondingly cause the encoding frequency of the encoded signal ECS to sequentially increase from low to high. The controller 510 can generate and obtain the user's input command INCMD based on the variation trend of the encoding frequency of the encoded signal ECS.

Based on the above, the input device of the invention is provided with an encoding plate, and the first contact on the encoding plate is connected or not connected with each of the second contacts via a connecting structure to adjust the connection relationship between a plurality of capacitors on the second contacts and the resonance circuit. Thereby, the sending action of the input command of the user can correspondingly adjust the equivalent capacitance value on the resonance circuit and adjust the encoding frequency of the encoded signal. In this way, the input device of the invention may obtain an input command by analyzing the changing trend of the encoding frequency of the encoded signal, and may still correctly interpret the input command under the operation of high-speed report rate.

What is claimed is:

1. An input device, comprising:
an encoding plate having N fields, wherein each of the fields has M partitions, there is an electrode on at least one of the partitions of each of the fields, the electrodes on each of the corresponding partitions in the fields are electrically coupled to each of a plurality of contacts, wherein the contacts comprise a first contact and M−1 second contacts, wherein N=2^{M-1}, and M is an integer greater than 1;
a connecting mechanism configured to determine whether to connect at least one of the first contact and the second contacts;
a resonance circuit electrically coupled to the first contact and configured to provide an encoded signal having an encoding frequency; and
M−1 first capacitors electrically coupled between the second contacts and the resonance circuit respectively.

2. The input device of claim 1, wherein the resonance circuit comprises:
an inductor;
a second capacitor coupled in parallel with the inductor,
wherein the inductor is used to sense an electromagnetic wave signal, and the resonance circuit generates the encoded signal based on the electromagnetic wave signal.

3. The input device of claim 2, wherein the connecting mechanism disconnects the first contact from any of the second contacts.

4. The input device of claim 2, wherein the connecting mechanism selects at least one of the second contacts as at least one selected contact, and electrically couples the second capacitor in parallel with each first capacitor corresponding to the at least one selected contact.

5. The input device of claim 1, wherein the encoding plate has a central portion, the fields surround the central portion, and the partitions of each field radiating outward from the central portion.

6. The input device of claim 5, wherein the partition closest to the central portion is a first partition, and each electrode is disposed in the first partition of each field.

7. The input device of claim 6, wherein the connecting mechanism comprises a first connecting end and M−1 second connecting ends, the first contact is electrically coupled to the electrodes in the first partition, and each of the second connecting ends is electrically coupled to the electrodes of a different partition other than the first partition.

8. The input device of claim 1, wherein the presence or absence of each electrode on each partition in each field corresponds to a binary value, and a plurality of digital values respectively corresponding to the fields are distinct from one another.

9. The input device of claim 1, wherein the encoding frequency of the encoded signal undergoes N changes based on a connection state between the second contacts and the first contact.

10. The input device of claim 1, further comprising:
a controller electrically coupled to the resonance circuit and configured to obtain an input command based on the encoding frequency of the encoded signal.
